(19) United States
(12) Patent Application Publication
(10) Pub. No.: US 2018/0006341 A1
(43) Pub. Date: Jan. 4, 2018

(54) METHOD AND APPARATUS FOR ATTACHING BATTERY TEMPERATURE SENSOR

(71) Applicant: Faraday&Future Inc., Gardena, CA (US)

(72) Inventors: Nabiha Iqra, Los Angeles, CA (US); Kameron Buckhout, Inglewood, CA (US)

(21) Appl. No.: 15/199,271

(22) Filed: Jun. 30, 2016

(51) Int. Cl. H01M 10/48; B60L 11/18

(52) U.S. Cl. CPC H01M 10/486; B60L 11/187

(57) ABSTRACT

An assembly is provided for attaching a temperature sensor to a battery cell. The assembly may comprise a sleeve having a hollow interior, the hollow interior being shaped to slide at least partially over the battery cell to a position on the battery cell. The assembly may further comprise a housing mounted on an exterior surface of the sleeve, the housing having an opening sized to accept the temperature sensor. The sleeve and the housing may provide thermal conductivity between the hollow interior of the sleeve and an interior of the opening of the housing, to facilitate thermal coupling between the battery cell and the temperature sensor.

### BACKGROUND

Aspects of the disclosure relate to a method and apparatus for attaching a temperature sensor (e.g., thermistor) to a battery cell. Batteries in electric vehicles operate with high power output which can increase the temperature and hence may reduce the longevity of the batteries. Conversely, if the batteries are too cold, the amount of charge they can deliver is adversely affected. Cooling, heating, or other thermal management systems are used to manage the temperature of the batteries within a desired range. Such systems require measuring the temperature of the battery, such as through the use of a thermistor or other temperature sensor.

It is desirable to attach a temperature sensor in a manner that will provide a consistent, durable connection and thermal coupling through all the vibrations during use of the vehicle. Also, it is desirable to have an attachment mechanism that is inexpensive and does not add undue complications to the manufacturing process. Embodiments of the invention address these problems, both individually and collectively.

### BRIEF SUMMARY

Certain embodiments are described that provide an assembly for attaching a temperature sensor to a battery cell. The assembly may comprise a sleeve having a hollow interior, the hollow interior being shaped to slide at least partially over the battery cell to a position on the battery cell. The assembly may further comprise a housing mounted on an exterior surface of the sleeve, the housing having an opening sized to accept the temperature sensor. The sleeve and the housing may provide thermal conductivity between the hollow interior of the sleeve and an interior of the opening of the housing, to facilitate thermal coupling between the battery cell and the temperature sensor.

In some embodiments, the assembly further comprises a thermally conductive element filling at least a portion of the housing and providing a thermal connection between the housing and the temperature sensor.

In some embodiments, the thermally conductive element comprises a thermally conductive epoxy. The thermally conductive epoxy may serve to retain the temperature sensor within the housing.

In some embodiments, the sleeve is rigid. In some embodiments, the battery cell and the sleeve are cylindrical.

In some embodiments, the sleeve and the housing are constructed of a metal material. The sleeve and the housing may be constructed of the same material as an outer surface of the battery cell.

### BRIEF DESCRIPTION OF THE DRAWINGS

Aspects of the disclosure are illustrated by way of example. In the accompanying figures, like reference numbers indicate similar elements.

FIG. 1A shows a sleeve and housing for a temperature sensor according to an embodiment;

FIG. 1B shows three sleeves and housings for a temperature sensor mounted on a heating plate according to an embodiment;

FIG. 2 shows the positions of thermistor sleeves on a plurality of cells in a battery cell array according to an embodiment;

FIG. 3 shows an assembly process according to an embodiment; and

FIG. 4 illustrates an example of a computing system in which one or more embodiments may be implemented.

### DETAILED DESCRIPTION

Examples are described herein in the context of an electric vehicle thermal management system. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

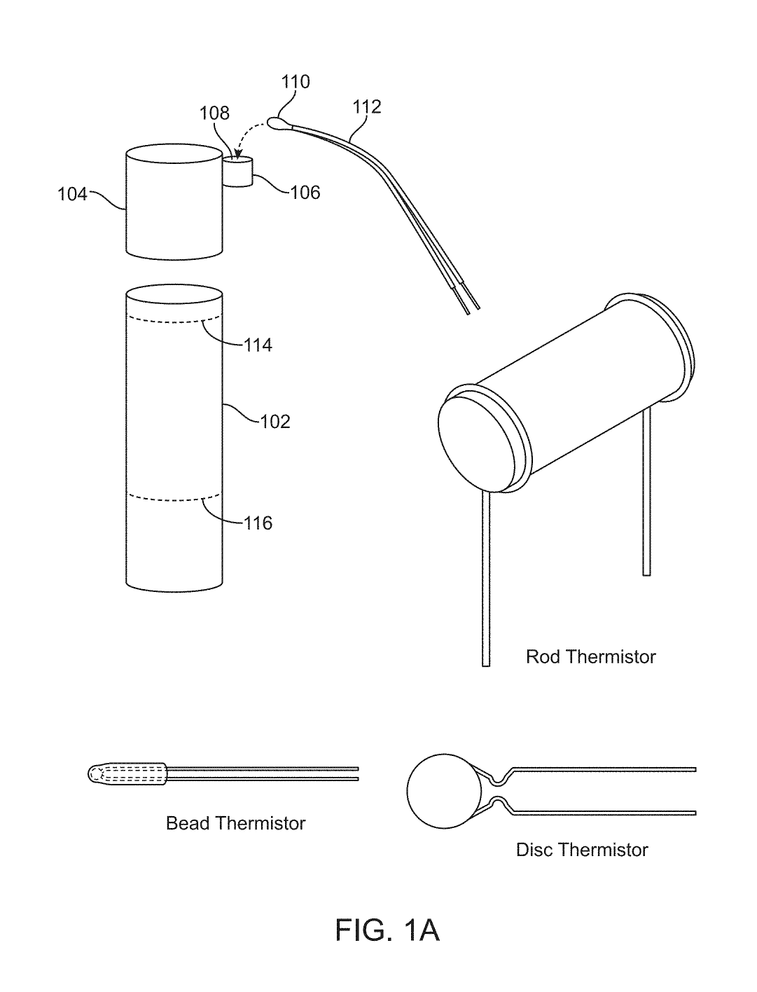

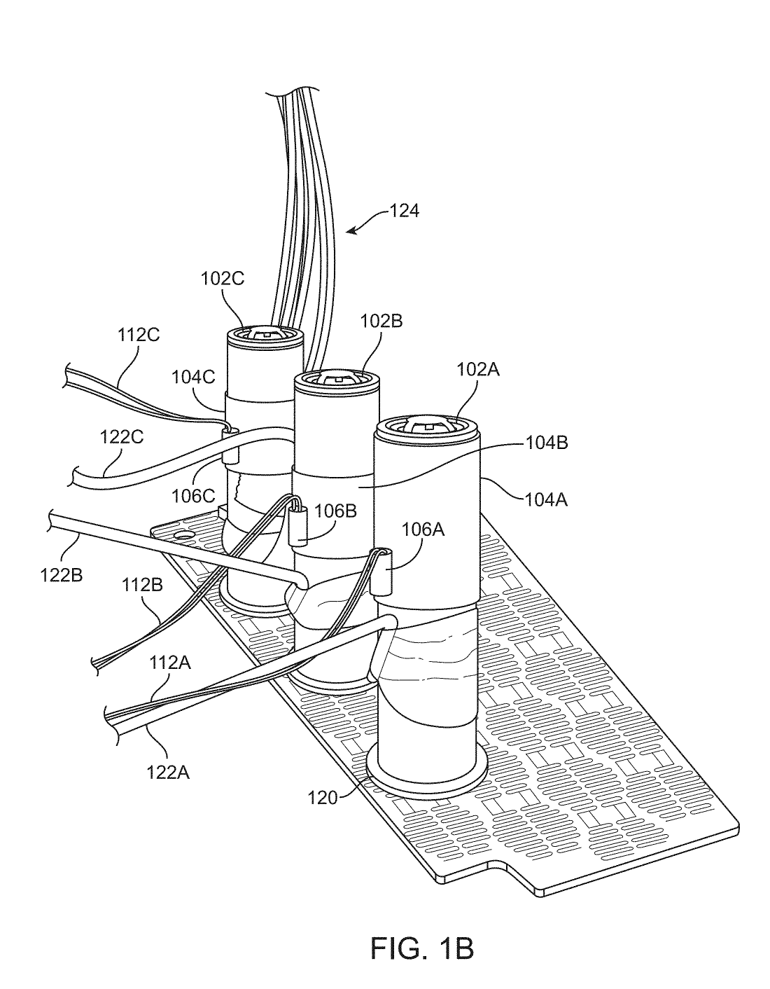

In one illustrative example, FIG. 1A shows a rigid sleeve 104 that can easily be placed over a cylindrical battery cell 102 during manufacture or assembly of a battery system for an electric vehicle or other use. The sleeve 104 is also cylindrical, with a slightly larger diameter, to fit over cell 102. The sleeve contacts the cell at an interior portion separated from the ends of the cell. Alternately, the sleeve can be conical or another shape. A housing 106 attached to the sleeve 104 receives a temperature sensor, such as a thermistor 110. A thermally conductive element 108 fills at least a portion of the housing, and provides a thermal connection between the temperature sensor and the housing. Thus, a durable connection is made that is easy to assemble, by slipping the sleeve 104 over a battery cell in the assembly process.

Housing 106 may be integrally formed with sleeve 104 when the sleeve is stamped, cast, or otherwise manufactured. Alternately, housing 106 can be welded, soldered, glued, or attached with epoxy to sleeve 104. Sleeve 104 and housing 106 can be the same or different materials, so long as they are thermally conductive. For example, a metal can be used, such as a metal with high thermal conductivity. The metal may possess some degree of malleability to allow a press-fit. In certain embodiments, sleeve 104 and housing 106 are constructed using the same type of metal as the outer body of cell 102. Such matching of metal material may produce better thermal coupling. For example, aluminum, copper, or other thermally conductive materials can be used. In one embodiment, the sleeve is a flexible, thermally conductive material, such as a metal mesh or expandable wire cage.

The sleeve and housing with the thermally conductive element (e.g., thermally conductive epoxy) provides maximum contact between the temperature sensor (e.g., thermistor bead) and the cell by eliminating any air pocket when such sensors are glued/taped directly to the body of the cell without the housing. Unlike prior art gluing or taping techniques, the thermally conductive element and the housing surround the temperature sensor, so that all sides receive conducted heat. The bonding or attachment of the housing to the sleeve, and the extensive contact between the sleeve and the cell, assure a good and fast thermally conductive path to the temperature sensor.

Housing 106 can be mounted near the top of sleeve 104 for ease of access, but alternately could be attached near the middle or end. Housing 106 can be any shape that will accept thermistor 110, and could be attached to the exterior of sleeve 104.

In one particular embodiment, housing 106 is attached closer to the top of sleeve 104 to allow temperature measurement at a certain height on the body of cell 102. In such a configuration, even if sleeve 104 slides down to a position near the bottom of cell 102, housing 106 would still be positioned at a certain height above and away from the bottom of cell 102. This embodiment may be particularly helpful, for example, when the bottom of cell 102 is heated or cooled by an additional component (e.g., a heating plate, discussed later in this disclosure), and the temperature at the bottom of cell 102 is dominated or otherwise impacted by the additional heating/cooling component. In such a case, it may be advantageous to measure the temperature of cell 102 at a height above the bottom of cell 102, and the placement of housing 102 closer to the top of sleeve 104 can effectively ensure such measurement.

Referring still to FIG. 1A, leads 112 are attached to the thermistor. The leads can be attached into a wire harness along with leads from other thermistors. Multiple harnesses could be used, such as for leads near the top of the array, and leads near the bottom of the array, or on different sides of the array.

Sleeve 104 can be adjusted to different positions on cell 102. For example, the top of sleeve 104 may be at line 114 or line 116, or any other location. The top of the sleeve can extend above the cell. Alternately, the sleeve can be pushed all the way into contact with a heating plate for the cell array. Tests results have shown that the thermistor is effective at any of these positions.

FIG. 1B illustrates a few battery cells out of a larger array. Battery cells 102A, 102B, and 102C are mounted on a heating plate 120. Sleeves 104A, 104B, and 104C are shown after being slid over the cells. As can be seen, the sleeves can not only be at different positions along the battery cells, they can be different lengths. Housings 106A, 106B, and 106C are attached to sleeves 104A, 104B, and 104C, respectively, with corresponding thermistors inside. Leads 112A, 112B, and 112C are shown. Also shown are electrical connectors 122A, 122B, and 122C for providing charge to and from the battery cells.

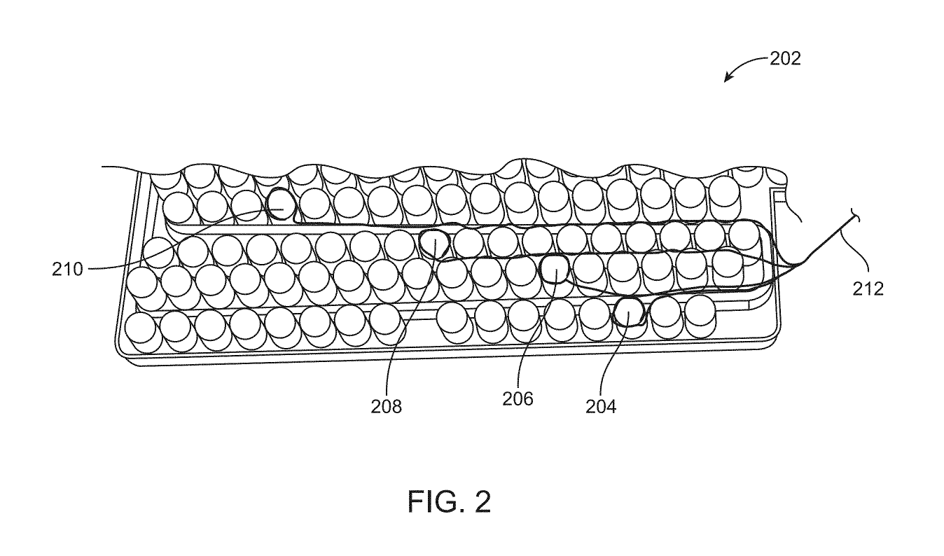

FIG. 2 illustrates the positions of thermistor sleeves on a plurality of cells in a battery cell array 202. Sleeves 204, 206, 208 and 210 are shown at different positions in the four rows of battery cells shown. The leads to the thermistors are attached to a wire harness 212.

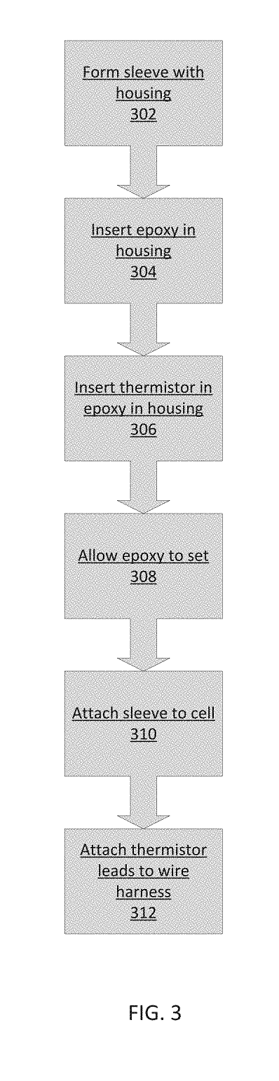

FIG. 3 shows an assembly process according to an embodiment. The sleeve and housing are first formed (step 302). This can be done by cast molding them together. Alternately, they can be molded separately and then welded, soldered, glued or otherwise attached together. Next, epoxy or another thermally conductive element is inserted into the housing (304). Alternately, the housing may be shaped to provide a snug fit with the thermistor to provide thermal conductivity and/or retain the thermistor without using epoxy. The thermistor is then inserted into the housing (306), and the epoxy is allowed to set (308). The sleeve is then attached to the battery cell (310) with a press fit or other method of making contact, at a desired location along the cell. The sleeve and the housing provide thermal conductivity between the hollow interior of the sleeve and an interior of the opening of the housing, to facilitate thermal coupling between the battery cell and the temperature sensor. The thermistor leads are connected to a wire harness and the computer system.

The epoxy or other element provides thermal conduction and also retains the thermistor in the housing. Alternately, a separate retaining mechanism could be used, such as a clip at the open which bends inward upon insertion of the thermistor, then locks into place.

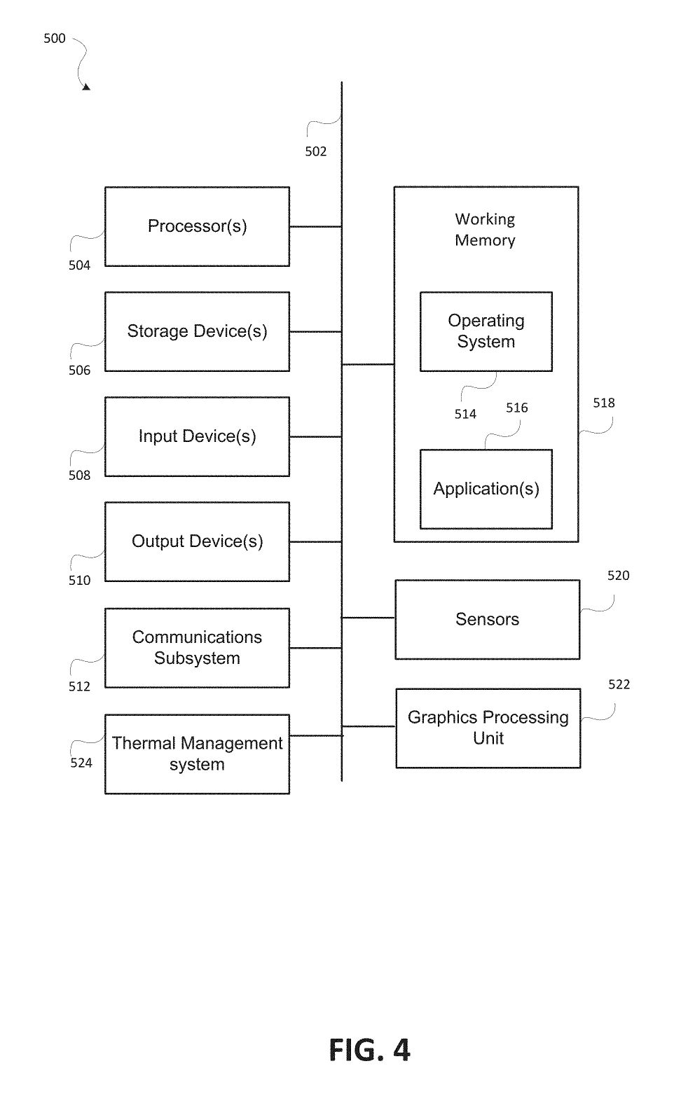

FIG. 4 illustrates an example of a computing system in which one or more implementations may be implemented. The thermistors can be connected to a vehicle's computing system, as sensors 520 shown in FIG. 4. The information from the thermistors is used to control a thermal management system 524. Processor 504 can analyze the thermistor data to establish a thermal profile of the battery pack, based on which cells the sleeves are attached to, corresponding temperature readings, and the position along the cell of each sleeve. In one embodiment, the position of the sleeves along the cells can be automatically determined by powering a heating plate, and determining which thermistors register the temperature rise first. The thermistors which register a heat increase first would be assumed to be positioned closer to the heating plate. Individual battery cells can also be monitored for thermal runaway or other cell failure.

A computer system as illustrated in FIG. 4 may be incorporated as part of a vehicular computing system. FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 500 is shown comprising hardware elements that can be electrically coupled via a bus 502 (or may otherwise be in communication, as appropriate). Bus 500 may be a Controller Area Network (CAN) bus that is typically used in vehicular applications for connecting microcontrollers and other electronics. The hardware elements may include one or more processors 504, including without limitation one or more general-purpose processors and/or one or more special-purpose processors (such as digital signal processing chips, graphics processing units 522, and/or the like); one or more input devices 508, which can include without limitation one or more cameras, sensors, a mouse, a keyboard, a microphone configured to detect ultrasound or other sounds, and/or the like; and one or more output devices 510, which can include without limitation a display unit such as the device used in implementations of the invention, a printer and/or the like. Additional cameras 520 may be employed for detection of user's extremities and gestures. In some implementations, input devices 508 may include one or more sensors such as infrared, depth, and/or ultrasound sensors. The graphics processing unit 522 may be used to carry out the method for real-time wiping and replacement of objects described above.

In some implementations of the implementations of the invention, various input devices 508 and output devices 510 may be embedded into interfaces such as display devices, tables, floors, walls, and window screens. Furthermore, input devices 408 and output devices 510 coupled to the processors may form multi-dimensional tracking systems.

The computer system 500 may further include (and/or be in communication with) one or more non-transitory storage devices 506, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 500 might also include a communications subsystem 512, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 512 may permit data to be exchanged with a network, other computer systems, and/or any other devices described herein. In many implementations, the computer system 500 will further comprise a non-transitory working memory 518, which can include a RAM or ROM device, as described above.

The computer system 500 also can comprise software elements, shown as being currently located within the working memory 518, including an operating system 514, device drivers, executable libraries, and/or other code, such as one or more application programs 516, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 506 described above. In some cases, the storage medium might be incorporated within a computer system, such as computer system 500. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 500 may be omitted or may be implemented separate from the illustrated system. For example, the processor 504 and/or other elements may be implemented separate from the input device 508. In one implementation, the processor may be configured to receive images from one or more cameras that are separately implemented. In some implementations, elements in addition to those illustrated in FIG. 4 may be included in the computer system 500.

Some implementations may employ a computer system (such as the computer system 500) to perform methods in accordance with the disclosure. For example, some or all of the procedures of the described methods may be performed by the computer system 500 in response to processor 504 executing one or more sequences of one or more instructions (which might be incorporated into the operating system 514 and/or other code, such as an application program 516) contained in the working memory 518. Such instructions may be read into the working memory 518 from another computer-readable medium, such as one or more of the storage device(s) 506. Merely by way of example, execution of the sequences of instructions contained in the working memory 518 might cause the processor(s) 504 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 500, various computer-readable media might be involved in providing instructions/code to processor(s) 504 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 506. Volatile media include, without limitation, dynamic memory, such as the working memory 518.

Transmission media include, without limitation, coaxial cables, copper wire, and fiber optics, including the wires that comprise the bus 502, as well as the various components of the communications subsystem 512 (and/or the media by which the communications subsystem 512 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 504 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various implementations of the invention.

The communications subsystem 512 (and/or components thereof) generally will receive the signals, and the bus 502 then might carry the signals (and/or the data, instructions, etc. carried by the signals) to the working memory 518, from which the processor(s) 504 retrieves and executes the instructions. The instructions received by the working memory 518 may optionally be stored on a non-transitory storage device 406 either before or after execution by the processor(s) 504.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

While some examples of methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. An assembly for attaching a temperature sensor to a battery cell comprising:
a sleeve having a hollow interior, the hollow interior being shaped to slide at least partially over the battery cell to a position on the battery cell; and
a housing mounted on an exterior surface of the sleeve, the housing having an opening sized to accept the temperature sensor,
wherein the sleeve and the housing provide thermal conductivity between the hollow interior of the sleeve and an interior of the opening of the housing, to facilitate thermal coupling between the battery cell and the temperature sensor.

2. The assembly of claim 1, further comprising a thermally conductive element filling at least a portion of the housing and providing a thermal connection between the housing and the temperature sensor.

3. The assembly of claim 2, wherein the thermally conductive element comprises a thermally conductive epoxy.

4. The assembly of claim 2, wherein the thermally conductive element further serves to physically retain the temperature sensor within the housing.

5. The assembly of claim 1, wherein the sleeve is rigid.

6. The assembly of claim 1, wherein the battery cell and the sleeve are cylindrical.

7. The assembly of claim 1 wherein the sleeve and the housing are constructed of a metal material.

8. The method of claim 7 wherein the sleeve and housing are constructed of the same metal material as an outer surface of the battery cell.

9. The assembly of claim 1, wherein the sleeve is placed at a position on the battery cell removed from end portions of the battery cell.

10. The assembly of claim 1, wherein the assembly is one of a plurality of assemblies, and the battery cell is part of a two dimensional array of battery cells, wherein the plurality of assemblies are fitted to a subset of battery cells in the two dimensional array of battery cells.

11. The assembly of claim 1 wherein the temperature sensor is a thermistor.

12. A method for attaching a temperature sensor to a battery cell comprising:
providing a sleeve having a hollow interior;
providing a housing mounted on an exterior surface of the sleeve, the housing having an opening on one side sized to accept the temperature sensor;
inserting the temperature sensor into in the housing;
securing the temperature sensor in the housing; and
sliding the housing at least partially over the battery cell with a contact to at least one point on the battery cell.

13. The method of claim 12 further comprising inserting a thermally conductive element to fill at least a portion of the housing and provide a thermal connection between the housing and the temperature sensor.

14. The method of claim 12, further comprising placing the sleeve at a position on the battery cell removed from end portions of the battery cell.

15. The method of claim 12, wherein the battery cell and the sleeve are cylindrical.

16. The method of claim 13, wherein the thermally conductive element is an epoxy.

17. The assembly of claim 12 wherein the sleeve and the housing are constructed of a metal material.

18. The method of claim 17 wherein the sleeve and housing are constructed of the same metal material as an outer surface of the battery cell.

19. The method of claim 12, further comprising securing the temperature sensor in the housing with a thermally conductive element.

20. An apparatus for attaching a temperature sensor to a battery cell comprising:
means for sensing temperature;
means for securing the means for sensing temperature in a housing;
means for providing thermal conductivity between the housing and the means for sensing temperature; and
means for attaching the housing to a battery cell by sliding the means for attaching along the battery cell.
